(19) United States
(12) Patent Application Publication
(10) Pub. No.: US 2019/0196083 A1
(43) Pub. Date: Jun. 27, 2019

(54) LIGHTING DEVICE AND IMAGE DISPLAY APPARATUS

(71) Applicant: SHARP KABUSHIKI KAISHA, Sakai City (JP)

(72) Inventors: NOBUAKI AOKI, Sakai City (JP); HIROMITSU TSUTSUI, Sakai City (JP)

(21) Appl. No.: 16/230,136

(22) Filed: Dec. 21, 2018

(30) Foreign Application Priority Data
Dec. 22, 2017 (JP) 2017-246848

(51) Int. Cl. F21V 8/00

(52) U.S. Cl. CPC G02B 6/0018; G02B 6/0068

(57) ABSTRACT

A lighting device includes light sources and a light guide having an obverse face, a reverse face, and an endface. The reverse face has a first light incident portion located near the endface. The obverse face has a second light incident portion located near the endface and a light emitting portion for emitting light incident from the first light incident portion and the second light incident portion. The endface has a concave portion formed along the longitudinal direction of the endface. The light sources are disposed in each of the first light incident portion and the second light incident portion so as to sandwich the concave portion. An image display apparatus includes this lighting device.

This Nonprovisional application claims priority under 35 U.S.C. § 119(a) on Patent Application 2017-246848 filed in Japan on 22 Dec. 2017, the entire contents of which are hereby incorporated by reference.

### BACKGROUND OF THE INVENTION

### (1) Field of the Invention

The present invention relates to a lighting device and an image display apparatus used in an image display apparatus with a LCD (Liquid Crystal Display).

### (2) Description of the Prior Art

Generally, liquid crystal display devices used as a display portion of a television set, a personal computer, a monitor and the like include a lighting device because LCDs do not produce light by themselves.

Such lighting devices are backlight type illuminators which illuminate the liquid crystal panel from its rear side. The backlighting systems are mainly categorized into two types, i.e., the edge light type (also called the side light system or the light guide system) and the direct type. For LCDs adopted for various kinds of small monitors and laptop personal computers, lighting devices of the edge light type are mainly used.

Regarding an edge light type lighting device, Japanese Patent Application Laid-Open No. 2013-89565 (Patent Document 1) discloses a flat lighting device unit. This flat lighting device unit includes, as shown in FIGS. 5 and 6, a light guide a0 and a light source unit c such as an LED (Light Emitting Diode) that emits light O incident on one endface b of the light guide a0. Here, the light guide a0 is constructed such that a light condensing regulator having fine convex portions for refracting light is provided on the surface a1 while a light reflecting regulator for reflecting light is provided on the reverse face a2 of the light guide a0, whereby the incident light is refracted and reflected so as to exit from the surface a1.

In the above flat lighting device unit, the light guide a0 guides light O so as to exit from the surface a1 toward an unillustrated light converter having fine apertures. A light regulating sheet having arcuate patterns for refracting light arrayed on the surface side is laid over the light converter.

In the flat lighting device unit of Patent Document 1, the light condensing regulator with fine convex patterns on the surface a1, the light converter with fine apertures and the light regulating sheet with arcuate patterns are adjusted in position so as to create a predetermined relationship, to thereby produce a highly luminous and clear image.

### PRIOR ART DOCUMENTS

### Patent Documents

### [Patent Document 1]

Japanese Patent Application Laid-Open No. 2013-89565

### Problems to be Solved by the Invention

However, in the flat lighting device unit described in the above Patent Document 1, there is a limit to the high luminance. Because in the lighting device unit the LEDs are arranged in a line, the number of LEDs that can be mounted on the light source unit is limited by the screen size of the image display apparatus.

In addition, in order to obtain a highly luminous and clear image in the flat lighting device unit of the above Patent Document 1, the light condensing regulator with fine convex patterns on the surface a1, the light converter with fine apertures and the light regulating sheet with arcuate patterns need to be adjusted so as to create a predetermined positional relationship. However, because the light guide a0, the light converter and the light regulating sheet are different in thermal expansion coefficient and the like, it is difficult to keep the predetermined positional relationship constant.

### SUMMARY OF THE INVENTION

The present invention has been devised in view of the above circumstances, it is therefore an object of the present invention to provide a lighting device which can achieve high luminance while suppressing cost without complicating the structure, as well as providing an image display apparatus provided with the lighting device.

### Means for Solving the Problem

The gist of the present invention resides in a lighting device, comprising: light sources; and a light guide having an obverse face, a reverse face, and an endface, wherein: the reverse face has a first light incident portion located near the endface; the obverse face has a second light incident portion located near the endface and a light emitting portion for emitting light incident from the first light incident portion and the second light incident portion; the endface has a concave portion formed along the longitudinal direction of the endface; and the light sources are disposed in each of the first light incident portion and the second light incident portion so as to sandwich the concave portion.

### Effect of the Invention

According to the lighting device of the present invention, in the lighting device including light sources and a light guide having an obverse face, a reverse face, and an endface, the reverse face has a first light incident portion located near the endface, and the obverse face has a second light incident portion located near the endface and a light emitting portion for emitting light incident from the first light incident portion and the second light incident portion. The endface has a concave portion formed along the longitudinal direction of the endface, and the light source is disposed in each of the first light incident portion and the second light incident portion so as to sandwich the concave portion. Therefore, since the light source can be arranged in the first light incident portion on the obverse face side of the light guide and the second light incident portion on the reverse face side, at least two light sources can be arranged (if multiple light sources are provided for each of the first and second light incident portions, a further increased number of light sources can be provided). In addition, as compared with the conventional case where only one light source directed to the endface of the light guide can be arranged, the number of light sources can be increased to enhance the intensity of light and easily achieve high luminance.

Further, in order to increase the luminance of a general image display apparatus, the configuration in Patent Document 1 needs to perform positional adjustment as to the fine light condensing regulator of the light guide, the fine apertures of the light converter and the patterns on the light regulating sheet. However, it is very difficult to always keep the positions of these components because these components have different coefficients of thermal expansion. Further, it is necessary to prepare these components with high dimensional accuracy, which causes a cost increase.

In contrast to this, according to the present invention, it is not necessary to consider such positional adjustment, and it is possible to use a general structure as it is for the sheets and the like, so it is possible to reliably achieve high luminance and achieve excellent effects without cost increase.

### BRIEF DESCRIPTION OF THE DRAWINGS

FIG. 1 is an illustrative diagram showing a vertical section of an image display apparatus according to a first embodiment of the present invention;

FIG. 2 is an illustrative diagram showing optical paths in a light guide of a lighting device in FIG. 1;

FIG. 3 is an illustrative diagram showing optical paths in a light guide in a lighting device according to a second embodiment of the present invention;

FIG. 4 is an illustrative diagram showing optical paths in a light guide in a lighting device according to a third embodiment of the present invention;

FIG. 5 is a perspective illustrative view of a light guide in a conventional lighting device; and

FIG. 6 is an illustrative diagram showing optical paths in a light guide in FIG. 5.

### DESCRIPTION OF THE PREFERRED EMBODIMENTS

Embodiments of the present invention will be described hereinbelow with reference to the accompanying drawings.

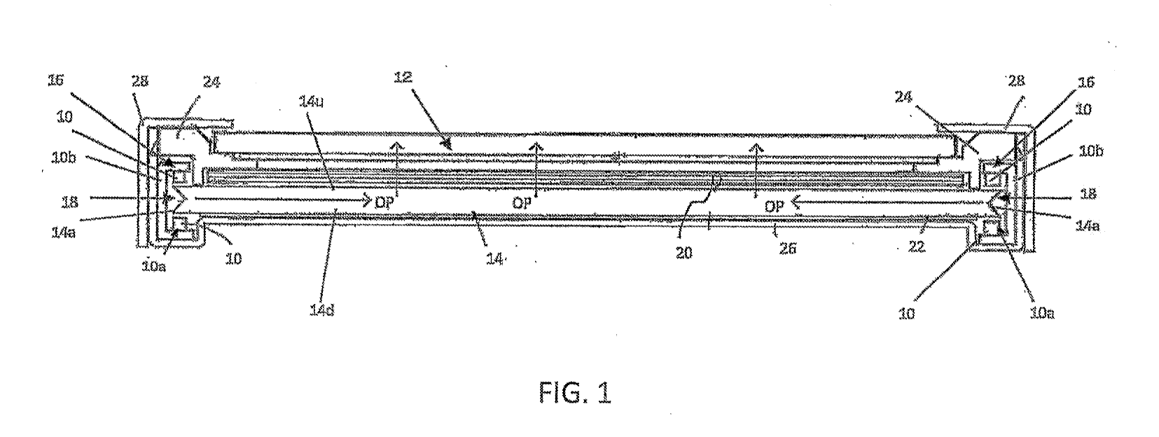

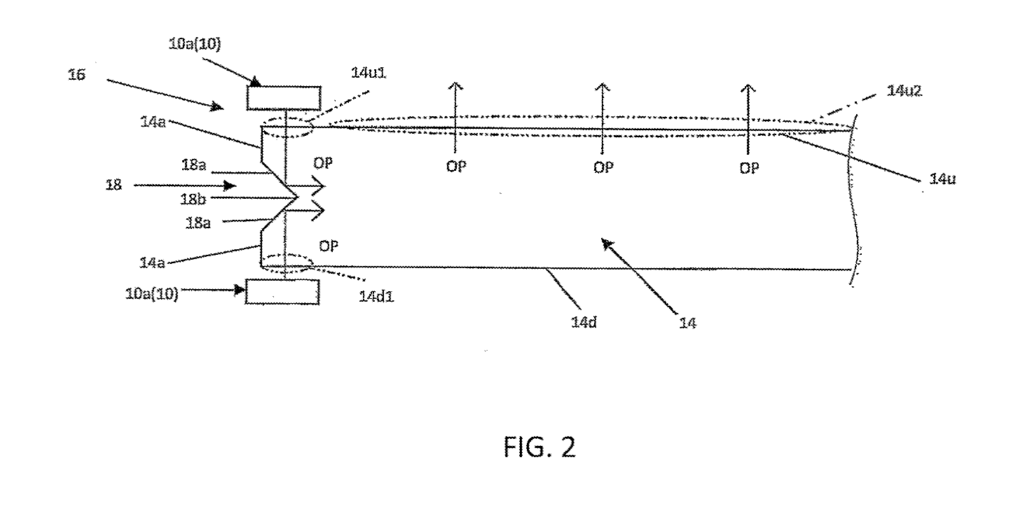

FIG. 1 is an illustrative diagram showing a vertical section of an image display apparatus according to a first embodiment of the present invention. FIG. 2 is an illustrative diagram showing optical paths OP in a light guide of a lighting device in FIG. 1.

### First Embodiment

As shown in FIG. 1, the image display apparatus according to the first embodiment includes a lighting device 16 including arrays of light sources 10 such as light emitting diodes (LEDs) and a light guide 14 for guiding the light emitted from the light sources 10 toward a display panel 12 as indicated by optical paths OP. More specifically, the lighting device 16 is formed of the light guide 14 whose obverse side opposes the display panel 12 and having a V-shaped groove (corresponding to a concave portion) 18 formed along the longitudinal direction (perpendicular to the surface of the drawing document in FIG. 1) of the endface, designated at 14a, and the arrays of light sources 10 (light sources 10, 10 at positions sandwiching the bottom facets 18a from the obverse side and the reverse side) arranged so as to sandwich the bottom facets 18a of the groove 18 on the obverse face 14u and the reverse face 14d of the light guide 14.

As shown in FIG. 2, the reverse face 14d has a first light incident portion 14d1 near the endface 14a so as to allow the light emitted from the lower array of light sources 10 (located on the reverse face 14d side of the light guide 14) to be incident thereon. Further, the obverse face 14u has a second light incident portion 14u1 near the endface 14a so as to allow the light emitted from the upper array of light sources 10 (located on the obverse face 14u side of the light guide 14) to be incident thereon and a light emitting portion 14u2 allowing the incident light from the first light incident portion 14d1 and the second light incident portion 14u1 to exit. In FIG. 2, the areas of the first light incident portion 14d1, the second light incident portion 14u1 and the light emitting portion 14u2 are indicated by two-dot chain lines.

In this arrangement, the light guide 14 forms light paths OP such that the light beams from the obverse and reverse arrays of light sources 10 and 10 enter the interior of the light guide 14 from the second light incident portion 14u1 of the obverse face 14u and the first light incident portion 14d1 of the reverse face 14d and are reflected on the bottom facets 18a and 18a of the groove 18 and led in the direction perpendicular to the endface 14a so that the thus led light can illuminate the display panel 12 through the light emitting portion 14u2 on the obverse face 14u side.

Specifically, the image display apparatus shown in FIG. 1 is a liquid crystal display device in which the display panel 12 is a liquid crystal panel.

This liquid crystal display device includes the lighting device 16 having the light sources 10, the light guide 14 and the like, a liquid crystal panel, i.e., the display panel 12 and an unillustrated circuit board for driving these components.

The lighting device 16 includes a light source unit 10a provided with the light sources 10, the light guide 14 for guiding light from the light sources 10 so as to illuminate the display panel 12, an optical sheet 20 disposed on the obverse face 14u side of the light guide 14 and a reflection sheet 22 disposed on the reverse face 14d side of the light guide 14, as well as including a P-chassis 24 made of resin and a rear metal sheet 26 which sandwich the above components from the obverse side and the reverse side. The display panel 12 is configured to be held and sandwiched between the lighting device 16 and a metallic bezel 28 from the obverse side and the reverse side.

FIG. 2 is a diagram schematically showing the light source unit 10a (on one side) and part of the light guide 14 in FIG. 1. A plurality light sources 10 are mounted on a long plate-like substrate. The substrates are arranged so as to oppose each other and fixed to the light source holder 10b having a U-shaped section with, for example, high heat radiation double-sided tape. Thus, the light sources 10 and the light source holder 10b constitute the light source unit 10a. The light source unit 10a is fixed by the rear metal sheet 26.

As the material of the plate-like substrate on which multiple LEDs as the light sources 10 are mounted, for example an FR4 substrate (an aluminum substrate is preferable if high power is expected) can be used. As the light source holder 10b, materials having a high thermal conductivity such as aluminum are preferably used. Here, the light source unit 10a may be removably mounted to the light guide 14. The array of light source 10 is arranged not on the endface 14a of the light guide 14 but on each of the obverse and reverse faces 14u and 14d of the light guide 14 so as to extend along the endface 14a of the light guide 14. Specifically, the arrays of light sources are arranged parallel to the longitudinal direction of the endface 14a of the light guide 14 (for example, arranged in the direction perpendicular to the document surface of FIGS. 1 and 2).

In the present embodiment, the groove (concave portion) 18 has a shape in which two facets adjoin each other so as to form a valley-like or V-shaped cross-section, and the valley line, designated at 18b, of the groove formed by the intersection of the two adjacent facets extend parallel to the longitudinal direction of the endface 14a.

Specifically, the groove 18 having a valley-like or V-shaped cross-section is formed on the endface 14a (each of left and right endfaces perpendicular to the obverse and reverse faces 14u and 14d in FIG. 1) of the light guide 14 along the longitudinal direction of endface 14a. The two bottom facets 18a, 18a forming the V-shaped section of the groove 18 intersect each other to form the valley line 18b of the groove. The groove 18 is parallel to the valley line (the direction perpendicular to the surface of the drawing document in FIG. 1 or FIG. 2) formed by the obverse face 14u of the light guide 14 and the endface 14a while the two bottom facets 18a, 18a extending from the valley line 18b of the groove toward the endface 14a are angled 45 degrees with respect to the obverse and reverse faces 14u and 14d of the light guide 14, respectively.

As shown in FIG. 1, the endface 14a of the light guide 14 may be formed with the groove 18 from the edge to the edge (from the obverse face 14u to the reverse face 14d). Alternatively, as shown in FIG. 2 the groove 18 may be incised in part of the endface 14a. The bottom facets 18a and 18a of the grooves 18 intersect at 90 degrees but 90 degrees is not always necessary, and the angle between the two bottom facets 18a and 18a can freely be set at an angle form 60 to 120 degrees.

As shown in FIG. 2, as to the optical paths OP, the light from the light sources 10 is made incident along the directions parallel to the endface 14a of the light guide 14 (made incident in the thickness direction of the light guide 14). Then, the incident light is reflected in the direction perpendicular to the endface 14a by the bottom facets 18a, 18a of the groove 18 formed on the endface 14a of the light guide 14. When the position of the light guide 14 with respect to the light sources 10 varies due to a difference in thermal expansion coefficient (a difference in coefficient of thermal expansion between the light guide 14 and the rear metal sheet 26 to which the light source unit 10a is fixed), the layout is designed so that the above reflection can be retained throughout the range of variation. Alternatively, the layout may be designed so that the position of the light guide 14 with respect to the light sources 10 can be kept constant. The optical paths OP after being reflected in the direction perpendicular to the endface 14a are the same as those of a general image display apparatus so that it is possible to use the structure of the general image display apparatus as it is, for other than the structure of the groove 18.

As the material of the light guide 14, a resin with high transparency such as PMMA (Polymethyl Methacrylate) resin or PC (Polycarbonate) resin can be used.

Arranged on the light guide 14 side opposing the display panel 12 is the aforementioned optical sheet 20 such as a lens sheet or a diffusion sheet. The reflection sheet 22 is arranged on the opposite side of the light guide 14 from the aforementioned optical sheet 20. For these sheets, the general structure can be used as it is. It is also possible to provide a lighting device that does not have optical sheets, such as a see-through module. Further, well-known configurations can be used for the liquid crystal panel and the drive circuit board of the display panel 12, so the details will be omitted.

Operation and effects of the lighting device according to the present embodiment will be described.

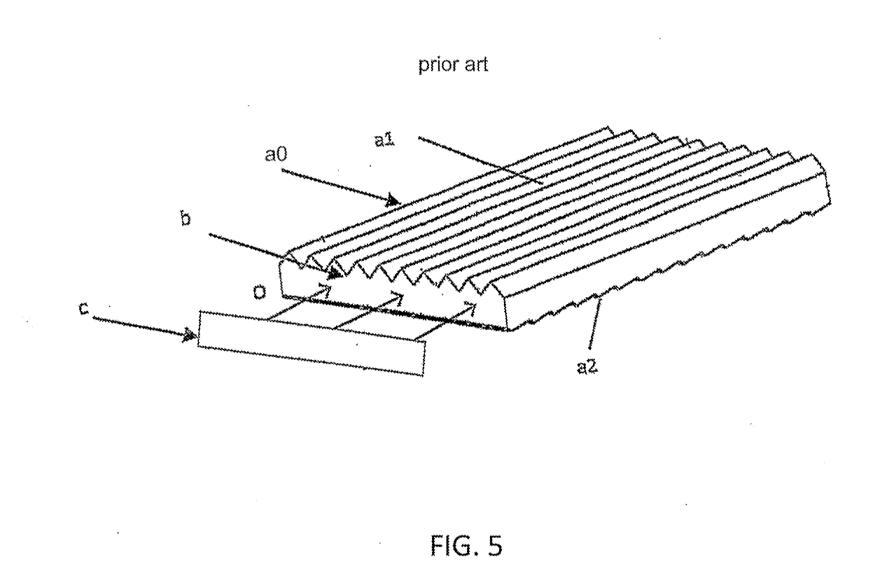

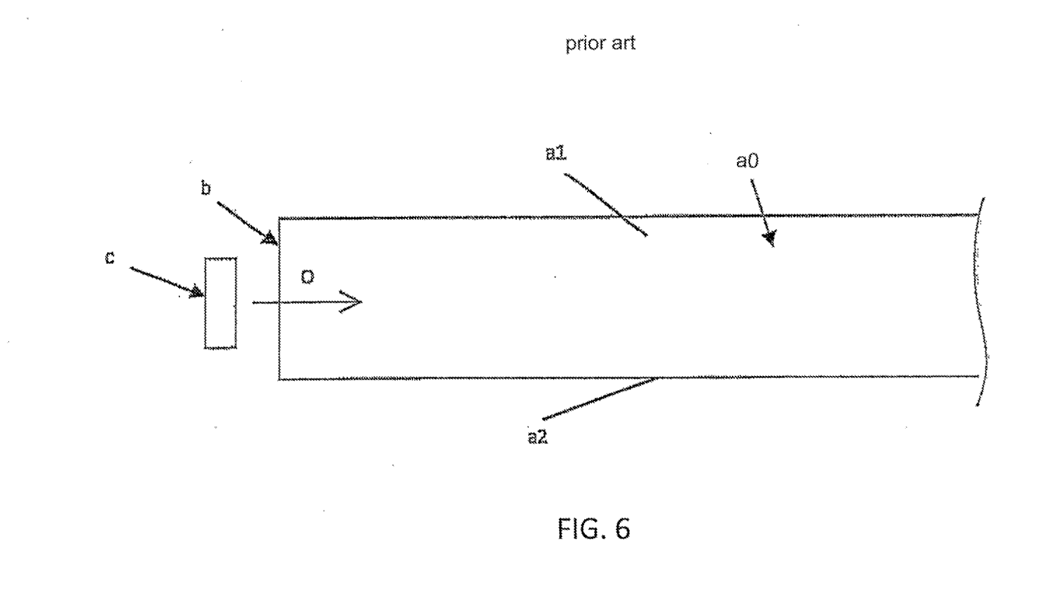

In the conventional lighting device (see FIGS. 5 and 6), light from the light source c is incident on the endface b of the light guide a. When an upward lighting LED whose mounted surface is parallel to the surface of light emission is used for the light source c, since the upward lighting LED has a greater width compared to the thickness of the light guide a, it is difficult to arrange multiple rows of LEDs, side by side, in view of the thickness of the light guide a (the thickness of the image display apparatus). Hence, one light source unit with only a single array of LEDs has been used conventionally. Therefore, in the prior art, the number of LEDs that can be mounted on the flat lighting device unit has an upper limit depending on the screen size of the image display apparatus, hence there is a limit in increasing the luminance.

In contrast to this, according to the present embodiment, when the light source units 10a are arranged on the obverse and reverse side in the vicinity of the endface 14a of the light guide 14, light sources 10 are disposed on each of the obverse face 14u and the reverse face 14d of the light guide 14, along the longitudinal direction of the endface 14a. That is, multiple arrays of light sources can be arranged. Even with the same size of the image display apparatus, the number of the light sources can be doubled as compared to the case where the light sources are provided on one of the endfaces of the light guide as disclosed in Patent Document 1. When the light sources 10 are arranged on both the left and right endfaces of the light guide 14 as shown in FIG. 1, a further increase is expected so that the number of the light sources 10 can be increased about four-fold. In this way, adoption of the present embodiment can facilitate increase of the number of light sources.

Further, in this case, the thicknesses of the light sources 10 and the light source holder 10b are added in the thickness direction of the image display apparatus, but the image display apparatus is not thickened by the same amount. In a general image display apparatus, the thicknesses of the light source and the light source holder are smaller than that of the light guide, and the width of the light source holder (the dimension of the light source holder in the thickness direction of the image display apparatus) is some several times that of the thickness of the light guide (as an example, the thickness of the light source is 1 to 2 mm, the thickness of the light guide is 3 to 5 mm, the width of the light source holder is 10 to 15 mm, the thickness of the light source holder is 1 mm). That is, the factor contributing to the thickness of the image display apparatus is the width of the light source holder. Accordingly, if, in the present embodiment, the light sources 10 are arranged by securing a certain amount of clearance between the light guide 14 and the light source holder 10b having a U-shaped cross-section, it is not necessary to increase the thickness of the image display apparatus so much. In some cases, it is possible to suppress the thickness to equivalent to the prior art.

Further, since the light source previously arranged facing the endface of the light guide does not exist in the present embodiment, the frame width (the distance from the border of the displayable area to the outward form of the image display apparatus) on the side where the light source is accommodated can be made smaller by the thickness of the light source. That is, even with the same screen size, the outward form can be reduced.

Further, in consideration of increasing the luminance of a general image display apparatus, it is necessary to prepare fine patterns on the light guide with high dimensional accuracy in Patent Document 1, which causes a cost increase. On the other hand, in the present embodiment, the optical path OP of light after being reflected on the bottom facet 18a is the same as that of a general image display apparatus, so that the light guide 14 having the same structure except the groove 18 can be used as it is. Therefore, it is possible to suppress the manufacturing cost.

Furthermore, in Patent Document 1, in order to achieve high luminance, it is necessary to align the fine light condensing regulator of the light guide, the light converter with fine apertures and the light regulating sheet with arcuate patterns, but it is very difficult to always keep the alignment of these components having different coefficients of thermal expansion. In addition, it is necessary to produce the light converter and the light regulating sheet with high dimensional accuracy, which is costly.

In contrast to this, in the present embodiment, it is not necessary to take such alignment into consideration and it is possible to use a general structure as it is for the sheets and the like, so it is possible to reliably achieve high luminance and achieve excellent effects without cost increase.

That is, the present embodiment facilitates provision of an image display apparatus with high luminance and a narrow frame. In addition, the present embodiment is not only applicable to ordinary image display apparatus, but can be applied further preferably to a see-through type display apparatus which is hard to increase luminance because of a lack of an optical sheet and to a 8K UHDTV ((8K Ultra High Definition Television), 8K is a video format with 7680 pixels in lateral direction and 4320 lines in vertical direction) having lower numerical apertures due to increased number of pixels.

### Second Embodiment

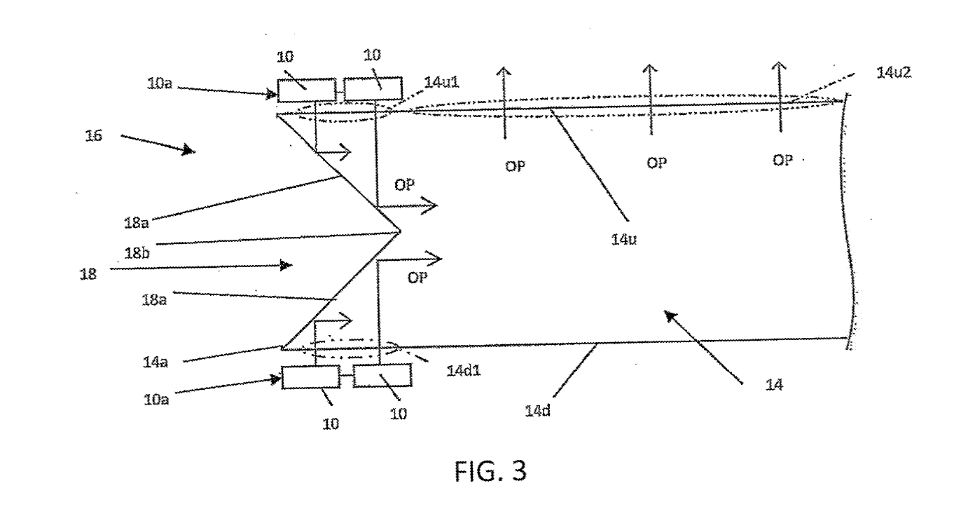

FIG. 3 is a diagram for explaining optical paths OP in a light guide 14 in a lighting device 16 according to the second embodiment of the present invention, schematically showing light source units 10a and part of the light guide 14. The same reference numerals are allotted to the same components as those in FIGS. 1 and 2.

As shown in FIG. 3, in the lighting device 16 according to the second embodiment, the depth of the groove (concave portion) 18 formed on the endface 14a of the light guide 14 is made deeper than that in the first embodiment while two arrays of light sources 10 and 10 are arranged along the direction parallel to the longitudinal direction of the endface 14a on each of the obverse face 14u and the reverse face 14d of the light guide 14. The light sources 10, 10, . . . are arranged parallel in the longitudinal direction of the endface 14a so as to sandwich the bottom facets 18a and 18a of the groove 18 from the obverse face side and the reverse face side of the light guide 14. Thus, the two arrays of light sources 10, 10 can be arranged parallel to the longitudinal direction of the endface 14a. In the light guide 14, as in the case described above with FIG. 2, light beams from the light sources 10 are made incident at a right angle on the obverse face 14u or the reverse face 14d of the light guide 14, then reflected on the bottom facets 18a, 18a of the groove 18 in the direction perpendicular to the endface 14a.

According to the optical paths OP in the light guide 14 of the lighting device 16 according to the second embodiment, the light sources 10, 10 . . . are disposed on both the obverse face 14u side and the reverse face 14d side of the light guide 14 so as to sandwich the bottom facets 18a of the groove 18. Since the multiple arrays of light sources 10 (the light sources 10, 10 . . . ) are arranged along the longitudinal direction of the endface 14a, it is possible to achieve further higher luminance by increasing the number of the light sources 10, 10 . . . (two or more arrays of light sources).

### Third Embodiment

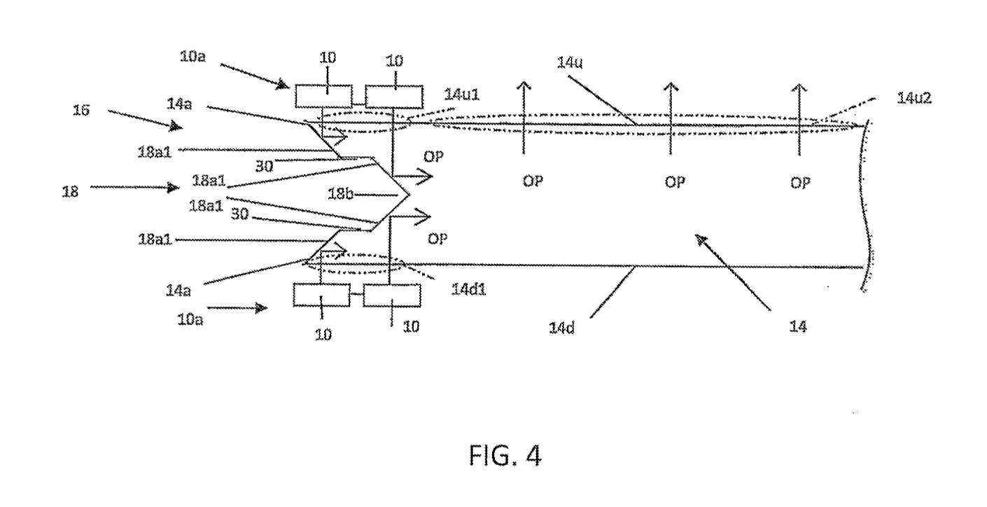

FIG. 4 is an illustrative diagram of optical paths OP in a light guide 14 of a lighting device 16 according to the third embodiment of the present invention, schematically showing light source units 10a and part of the light guide 14. The same reference numerals are allotted to the same components as those in FIGS. 1 and 2.

In the third embodiment, as shown in the sectional view in FIG. 4, a groove (depressed portion) 18 formed in the longitudinal direction of the endface of the light guide 14 is formed of a pair of bottom facets 18a1 and 18a1 inclined at a predetermined angle with the obverse face 14u and a pair of facets 30 between the paired bottom facets parallel to the obverse face 14u and a pair of bottom facets 18a1 and 18a1 inclined at a predetermined angle with the reverse face 14d and a facet 30 between the paired bottom facets parallel to the reverse face 14d. That is, the groove 18 on the endface of the light guide 14 has across-section in which the inclined bottom facets 18a1, 18a1 and the parallel facets 30 to the obverse and reverse faces 14u and 14d are combined stepwise. Specifically, the groove 18 formed in the endface includes an edged portion formed by the obverse face 14u and the bottom facet 18a1, the bottom facet 18a1, the parallel facet 30, the bottom facet 18a1, the groove's valley line 18b, the bottom facet 18a1, the parallel facet 30, the bottom facet 18a1 and an edge portion formed by the bottom facet 18a1 and the reverse face 14d.

More specifically, as shown in FIG. 4, two arrays of light sources 10, 10 are provided on each of the obverse face 14u side and the reverse face 14d side of the light guide 14 so as to extend in the longitudinal direction of the endface 14a of the light guide 14. Multiple bottom facets 18a1, 18a1 are formed separately along the direction perpendicular to the endface 14a in positions held between the obverse face 14u and the reverse face 14d corresponding to each of the arrays of light sources 10, 10 . . . while the bottom facets 18a1 and 18a1 are connected by the parallel facet 30 parallel to the obverse face 14u.

That is, the groove 18 has a shape in which the bottom facets 18a1, 18a1 are connected by the parallel facet 30. With this configuration, similarly to the case shown in FIG. 2, light beams from the two arrays of light sources 10, 10 are made incident in the direction along the endface 14a to the light guide 14, and then reflected by the bottom facets 18a1, 18a1 in the endface 14a, in the direction perpendicular to the endface 14a. In this case, it is desirable to design such that the position of the light guide 14 can be kept constant to the arrays of light sources 10, 10.

According to the third embodiment, since the bottom facets 18a1 and 18a1 are connected by the parallel facet 30, the groove 18 can be formed with a stepped structure of inclined facets and a flat facet. When multiple arrays of light sources 10 are provided in parallel in the longitudinal direction of the endface 14a of the light guide 14 in the configuration of the second embodiment shown in FIG. 3 in which a single inclined facet 18a is formed on either side, it is necessary to enlarge the inclined facet in consideration of the interference between the arrays of light sources 10, 10 arranged on the same side, which means increase in thickness of the light guide 14. In contrast to this, in the third embodiment, even if the arrays of light sources 10 and 10 interfere with each other, the positions of the bottom facets 18a1 and 18a1 can be shifted with respect to the direction perpendicular to the endface 14a without the need of increasing the thickness of the light guide 14. Accordingly, achievement of further higher luminance as in the above second embodiment can be realized by using a thinner light guide 14 than that of the second embodiment or with a thinner image display apparatus.

In the first to third embodiments, multiple arrays of light sources 10 may be appropriately arranged on the obverse face 14u and the reverse face 14d, along the longitudinal direction of the endface 14a: in the first embodiment, one array of light sources 10 is arranged on each side so as to be parallel to the longitudinal direction of the endface 14a; and in the second to third embodiments, two arrays of light sources 10 are arranged on each side in the direction perpendicular to the endface to configure a multiple light source arrangement. However, the present invention is not limited to these. That is, three or more arrays of light sources may be arranged in the direction perpendicular to the endface.

### INDUSTRIAL APPLICABILITY

The lighting device of the present invention can be used as a backlight of a liquid crystal display device.

### DESCRIPTION OF REFERENCE NUMERALS

10 light source
10a light source unit
10b light source holder
12 display panel
14 light guide
14a endface
14d reverse face
14u obverse face
16 lighting device
18 groove
18a bottom facet
18a1 bottom facet
18b groove's valley line
20 optical sheet
22 reflection sheet
30 parallel face
OP optical path

What is claimed is:

1. A lighting device, comprising:
light sources; and
a light guide having an obverse face, a reverse face, and an endface, wherein:
the reverse face has a first light incident portion located near the endface;
the obverse face has a second light incident portion located near the endface and a light emitting portion for emitting light incident from the first light incident portion and the second light incident portion;
the endface has a concave portion formed along the longitudinal direction of the endface; and
the light sources are provided in each of the first light incident portion and the second light incident portion so as to sandwich the concave portion.

2. The lighting device according to claim 1, wherein:
the concave portion is configured to have two adjacent facets intersecting each other forming a V-shaped cross-section; and
the intersection between two adjacent facets forms a valley line which extends in parallel with the obverse face or the reverse face of the light guide.

3. The lighting device according to claim 2, wherein the two adjacent facets are configured to intersect at an angle of 90°.

4. The lighting device according to claim 1, wherein the concave portion is configured to have a shape in which an inclined facet inclined at a predetermined angle with the obverse face and a flat facet parallel to the obverse face are formed adjacent to each other.

5. The lighting device according to claim 1, wherein a plurality of light sources are arranged in a direction parallel to the endface and in a direction perpendicular to the endface.

6. The lighting device according to claim 2, wherein a plurality of light sources are arranged in a direction parallel to the endface and in a direction perpendicular to the endface.

7. The lighting device according to claim 3, wherein a plurality of light sources are arranged in a direction parallel to the endface and in a direction perpendicular to the endface.

8. The lighting device according to claim 4, wherein a plurality of light sources are arranged in a direction parallel to the endface and in a direction perpendicular to the endface.

9. An image display apparatus comprising a liquid crystal panel and a lighting device according to claim 1.
